(19) United States
(12) Patent Application Publication
(10) Pub. No.: US 2011/0276484 A1
(43) Pub. Date: Nov. 10, 2011

(54) IDENTITY VERIFICATION SYSTEMS

(75) Inventors: Gregory A. Pearson, Dunedin, FL (US); Ronald Shane Hamilton, St. Petersburg, FL (US); David B. Hall, New Port Richey, FL (US)

(73) Assignee: Gregory A. Pearson, Inc., Dunedin, FL (US)

(21) Appl. No.: 12/773,457

(22) Filed: May 4, 2010

(51) Int. Cl. G06Q 40/00; G06K 7/10; G06K 9/00

(52) U.S. Cl. 705/44; 382/115; 235/380; 348/E07.085

(57) ABSTRACT

Identity verification systems and methods for remotely verifying a user's identity are disclosed. In some exemplary embodiments, the identity verification systems and methods may be used to verify an identity for a remote transaction. An exemplary embodiment of the system may comprise a capture unit, a delivery unit, a verification unit, a transaction unit, and a user account associated with the user. The capture unit may capture one or more verification images of the user, an identification document, and one or more other financial or identification documents. The delivery unit may transmit the verification documents to a server assembly. The verification unit may provide verification of the user's identity based on the verification images. The transaction unit may determined whether a transaction requested via the user's user account qualifies for verified status based on identity verification and, accordingly, whether the transaction should be afforded predetermined privileges of verified status.

### BACKGROUND

1. Technical Field

Various aspects of the present invention relate to identity verification systems and, more particularly, to identity verification systems for verifying identities from remote locations.

2. Description of Related Art

Because of the prevalence of remote communications, the popularity of remote transactions is steadily increasing. Various transactions occur via telephone, facsimile, internet, and other means of remote communication. These means of remote communication reduce or eliminate the need for face-to-face meetings.

With the increase of remote transactions comes a greater potential for identity theft and fraud. Identity fraud in remote transactions can be financially damaging not only to those whose identities are fraudulently used, but also to remote sellers approving sales to unauthorized users. For example, suppose a purchaser buys goods via a website using a name and account associated with an identity theft victim. When the victim becomes aware of the use of his account, he may contact his account servicer, or bank, and demand that the applicable funds be returned to his account on grounds that the purchase was unauthorized. The bank then refuses to pay for the purchased goods, and the website manager, which may have already delivered the goods, will not receive payment.

To reduce losses caused by identity fraud, various websites providing for the purchase of goods or services over the internet require some form of identity verification, particularly in the case of purchases for valuable products. Such websites generally require the purchaser to mail, fax, or email a photo identification of the purchaser to verify the purchaser's authorization to transact business with a particular line of credit or other financial account. Accordingly, the purchaser must locate a photocopy machine or scanner, so that the purchaser can duplicate identification documents and deliver them to a manager of the website. This verification process is unnecessarily time consuming for the purchaser and the website manager, who must organize and file the identification documents.

Therefore, there is a need for an identity verification system enabling efficient remote identity verification to protect one or more parties to remote transactions.

### SUMMARY

Exemplary embodiments of the present invention may include identity verification systems and methods enabling a system user's identity to be verified remotely for conducting remote transactions. The identity verification system may comprise a capture unit, a delivery unit, a verification unit, and one or more user accounts.

The capture unit may be configured to capture one or more verification images. For example, and not limitation, the capture unit may initiate capture of the verification images by transmitting a signal to a local computer. The transmitted signal may prompt a web camera, or other capture device, to capture the verification images. The verification images may include one or more images of a user, an identification document associated with the user, and a purchase card. For example, the verification images may include a first image of the user and a second image of an identification document, such as a photo identification card. The verification images may be stored, at least temporarily, on the local machine of the user.

The delivery unit may transmit the verification images from the local machine to a server assembly at a remote location from the user. The verification images may be encrypted or otherwise protected before being transmitted to the server assembly.

After transmission, the verification unit may verify the user's identity based at least partially on the verification images. The verification unit may compare the verification images to one another to verify the identity of the user. For example, an image of the user may be compared to an image of the user's identification document, such as a photo identification card, to verify that the user's face corresponds to a face on the photo identification card.

A user account may be associated with the user, and the verification images may be associated with the user account. The verification images may act as a signature for transactions, such as purchases, conducted through the user account.

Exemplary embodiments of the identity verification systems and methods may be implemented on computer hardware, computer software, or both. Accordingly, all or part of the identity verification systems and methods may be embodied in computer-readable media and may be executable by one or more computer processing units.

These and other objects, features, and advantages of the identity verification system will become more apparent upon reading the following specification in conjunction with the accompanying drawing figures.

### BRIEF DESCRIPTION OF THE FIGURES

FIG. 1 illustrates an architecture of a client computer utilizing an identity verification system, in accordance with an exemplary embodiment of the present invention.

FIG. 2 illustrates an architecture of a server assembly of the identity verification system, according to an exemplary embodiment of the present invention.

FIG. 3 illustrates a block diagram of the identity verification system, according to an exemplary embodiment of the present invention.

FIG. 4 illustrates a method of verifying an identity of a user and conducting a transaction, according to an exemplary embodiment of the present invention.

### DETAILED DESCRIPTION

To facilitate an understanding of the principles and features of the present invention, various illustrative embodiments are explained below. Exemplary embodiments of the invention comprise identity verification systems enabling remote identity verification, preferably for authorizing remote transactions. In particular, embodiments of the identity verification system are described in the context of a remote verification system for authorizing remote purchases. Embodiments of the invention, however, are not limited to this context. Rather, embodiments of the invention may authorize various types of transactions, such as mortgage or other loan applications, and may be utilized for local as well as remote verification.

The components described hereinafter as making up various elements of the invention are intended to be illustrative and not restrictive. Many suitable components that would perform the same or similar functions as components described herein are intended to be embraced within the scope of the identity verification system. Such other components not described herein may include, but are not limited to, for example, components developed after development of the invention.

Referring now to the figures, wherein like reference numerals represent like parts throughout the views, various embodiments of the identity verification systems and methods will be described in detail.

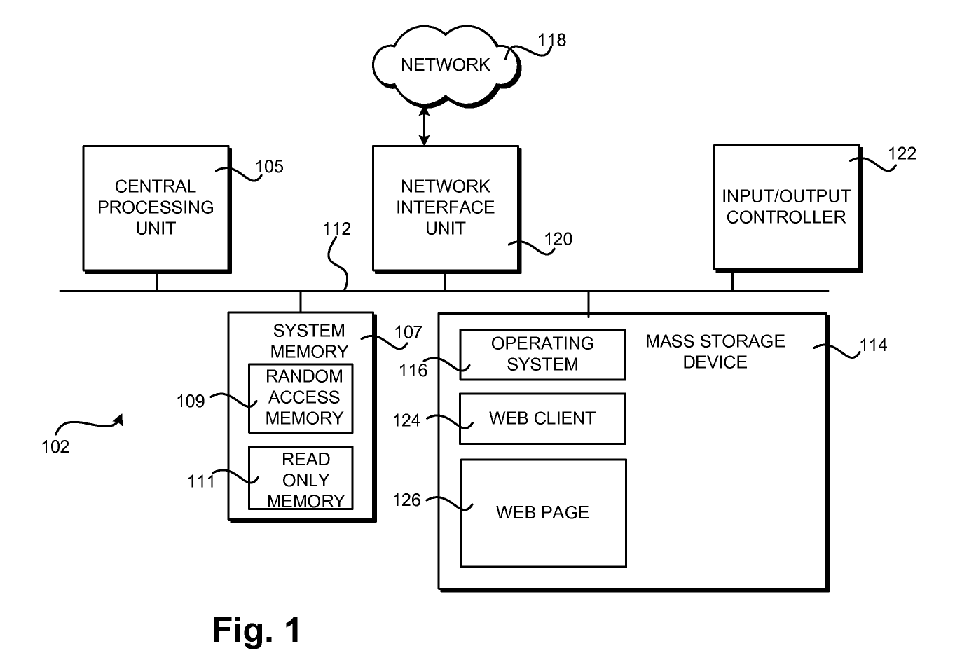

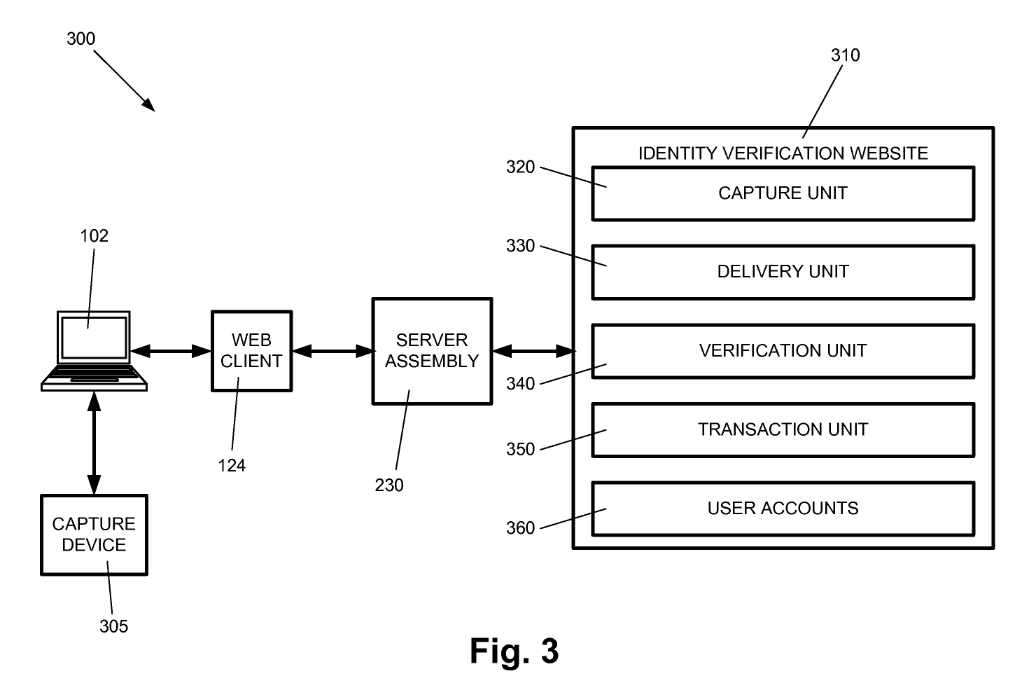

FIG. 1 illustrates a computer architecture for a local machine 102, such as a client computer, in accordance with an exemplary embodiment of the present invention. The client computer 102 may be used to access an identity verification website 310 (FIG. 3). Those skilled in the art will recognize that the general architecture described in reference to FIG. 1 is for example only, and may be modified to accommodate various embodiments of the identity verification system 300 (FIG. 3) and particular operational environments. As shown in FIG. 1, the client computer 102 may comprise a central processing unit 105 (“CPU”) and one or more system memories 107, such as a random access memory 109 (“RAM”) and a non-volatile memory, such as a read-only memory (“ROM”) 111. The client computer 102 may further comprise a system bus 112 coupling together the memory 107, the CPU 5, and various other components. A basic input/output system containing routines to assist in transferring information between components of the client computer 102 may be stored in the ROM 111.

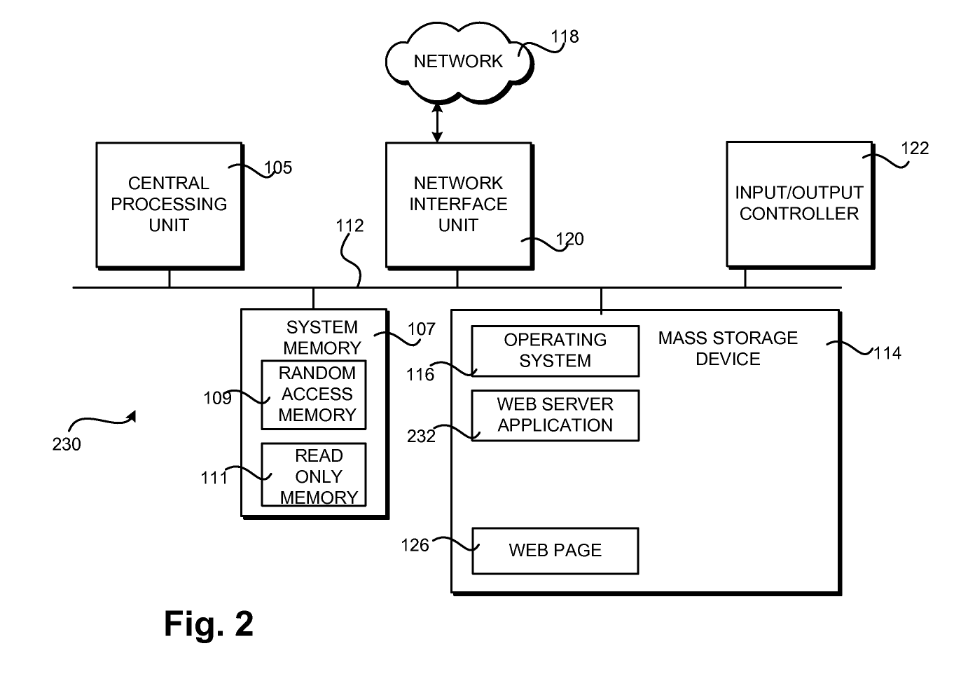

The client computer 102 may comprise, or may be associated with, various forms of computer-readable media. One such form of computer-readable media may be embodied in a mass storage device 114. Although the description of computer-readable media contained herein generally refers to a mass storage device 114, such as a hard disk or CD-ROM drive, it will be appreciated by those skilled in the art that computer-readable media may include many available media accessible by the client computer 102 or a server assembly 230 (FIG. 2). The mass storage device 114 may store an operating system 116, application programs, and other program units. The mass storage device 114 may be connected to the CPU 105 through a mass storage controller (not shown) connected to the bus 112. The mass storage device 114 may provide non-volatile storage for the client computer 102.

Computer-readable media may include computer storage media, such as volatile and non-volatile, removable and non-removable media implemented in many methods or technologies for storage of information, such as computer-readable instructions, data structures, program units, or other data. Computer storage media may include, but is not limited to, RAM, ROM, EPROM, EEPROM, flash memory, other solid state memory technology, CD-ROM, digital versatile disks (“DVD”), other optical storage, magnetic cassettes, magnetic tape, magnetic disk storage, other magnetic storage devices, or many other media that may be used to store the desired data and may be accessible by the client computer 102 or the server assembly 230. Computer-readable instructions on the storage media of the client computer 102 may include, for example, instructions for implementing processes, preferably client-side processes, of the identity verification system 300.

According to various embodiments, the client computer 102 may operate in a networked environment using logical connections to remote computers, such as the server assembly 230, through a network 118, such as the Internet. The client computer 102 may connect to the network 118 through a network interface unit 120 connected to the bus 112. It will be appreciated that the network interface unit 120 may also be utilized to connect to other types of networks and remote computer systems.

The client computer 102 may also include an input/output controller 122 for receiving and processing input from a number of other devices, including a keyboard, mouse, or electronic stylus. The input/output controller 122 may provide output to a display screen, a printer, or other type of output device.

A number of program units and data files may be stored in the mass storage device 114 and RAM 109 of the client computer 102. Such program units and data files may also include an operating system 116 suitable for controlling operations of a networked personal computer. A web browser application program, or web client 124, may also be stored on the mass storage device 114 and the RAM 109. The web client 124 may comprise an application program for requesting and rendering web pages 126 created in Hypertext Markup Language (“HTML”) or other types of markup languages. The web client 124 may also be capable of executing client side objects, as well as scripts through the use of a scripting host. The scripting host executes program code expressed as scripts within the browser environment.

Referring now to FIG. 2, a server assembly 230 utilized in various exemplary embodiments of the identity verification system 300 is illustrated. The server assembly 230 may service the website 310 by receiving and responding to requests from web clients 124. The server assembly 230 may comprise various combinations of hardware and software for servicing the website 310. Those skilled in the art will recognize that the server assembly 230 described in FIG. 2 is an exemplary server configuration and may be modified to accommodate various embodiments of the identity verification system 300. As shown in FIG. 2, the server assembly 230 may include many of the conventional computing components included in the client computer 102 and described above with respect to FIG. 1. In particular, the server assembly 230 may include a CPU 105, a network interface unit 120 connected to a network 118, such as the Internet, a system memory 107, and a mass storage device 114.

The mass storage device 114 utilized by the server assembly 230 may typically be operative to store an operating system 116 suitable for servicing the website 310 and controlling operations of a server computer. The mass storage device 114 and its associated computer-readable storage media provide non-volatile storage for the server assembly 230. Computer-readable instructions on computer-readable storage media of the server assembly 230 may include, for example, instructions for implementing processes, preferably server-side processes, of the identity verification system 300.

The server assembly 230 may utilize a web server application 232. The web server application 232 may receive and respond to requests from web clients 124 at remote computers, such as the client computer 102, for web pages 126 located at or accessible to the server assembly 230. It will be appreciated that web pages 126, as described herein, include both those pages stored statically and utilizing only HTML, as well as pages generated dynamically through use of server-side scripting technologies.

FIG. 3 illustrates a block diagram of the identity verification system 300, according to an exemplary embodiment of the present invention. As shown, an exemplary identity verification system 300 may comprise a local machine 102, a capture device 305, a web client 124, a server assembly 230, and the identity verification website 310. The local machine 102 may be in communication with, and operatively connected to, the capture device 305. Accordingly, the capture device 305 may be associated with the local machine 102 and a user at the local machine 102. Via the local machine 102, a user may access the website 310, which may be hosted by the server assembly 230, via the web client 124.

Through use of the local machine 102, the capture device 305, and the web client 124, a user may verify his identity to the identity verification website 310, which may be serviced by the server assembly 230. For example, the user may log into the website 310 and may indicate that he wishes to have his identity verified. The website 310 may then initialize an identity verification process, which may have one or more capturing steps. Each capturing step of the identity verification process may include capturing a verification image of the user or of one or more objects or entities placed in a field of view of the capture device 305. For example, verification images may be captured of the user's face, a first identification document, and a second identification document. In some embodiments of the identity verification system, the second identification documents may be a purchase device, such as a credit card, which can be used to verify identity, purchase authorization, or both.

After one or more of such verification images are captured, the identity verification system 300 may compare the verification images to one another. For example, and not limitation, a first verification image showing the user's face may be compared to a face on a photo identification card shown in a second verification image. These comparisons may verify that the user is the person named on the identification card.

The identity verification system 300 may also receive purchase information, such as information related to a checking account or a credit or debit card, which may include, for example, account number, name on the account, billing address, date of birth, or other information. Upon prompting, the user can enter this purchase information into the identity verification system 300 through an input device. One or more images of a purchase device, such as a check, credit card, debit card or other purported purchase authorization, may be included in the captured verification images as well. In some embodiments of the identity verification system 300, financial information, including verification images of a purchase device, need not be stored for longer than necessary to forward the financial information to a third party. The third party may then facilitate financial transactions on behalf of the identity verification system 300 when purchases are made.

For further verification, the identity verification system 300 may contact one or more outside sources, or third parties, to assist in the verification process. For example, and not limitation, a financial company that services the purchase device may be contacted to verify authenticity of the purchase device captured in a verification image, and to verify that an account holder name corresponds to a name indicated by the user or a name on the identification card. The financial company records may be compared to the user input and captured images to verify that the name, billing address, birth date, or other information that was input or captured corresponds to the information in the company's records.

The capture device 305 may comprise various devices for capturing an image, such as a photograph or video. For example, and not limitation, the capture device 305 may comprise a web camera or other digital camera.

The capture device 305 may comprise or be in communication with a specialized light source, such as a black light source or ultraviolet light source, for illuminating protective content or properties of official documents. For example, the specialized light may illuminate a holographic watermark on a photograph identification card to enable effective capture of the watermark in an image taken by the capture device 305. The capture device may be connected to the local machine 102, such that the capture device may receive one or more signals from the local machine 102 to capture one or more images.

The server assembly 230 may host the identity verification website 310, and may comprise or be in communication with one or more storage devices for retaining data, optionally including data provided by the capture device 305.

The identity verification website 310 may comprise one or more units, or modules, for implementing various tasks of the identity verification system 300. These units may comprise, among others, various combinations of a capture unit 320, a delivery unit 330, a verification unit 340, and a transaction unit 350.

Users of the identity verification website 310 may comprise various categories of entities, such as persons, organizations, or businesses. Each user may be associated with one or more user accounts 350, through which the users may conduct transactions via the website 310.

The identity verification system 300 may be initiated through various means. For example, the website 310 may initiate the identity verification system 300 automatically upon occurrence of a predetermined condition, such as creation of a user account 360 or use of an unverified local machine. Alternatively, the user may affirmatively request identity verification via the identity verification system 300. Once initially verified, a user need not repeat the verification process unless so desired, such as to confirm authorized use of the user's account at a local machine that is not yet linked to the user's verification.

Identity verification may benefit users of the website 310 by affording verified status to one or more transactions of users having verified identities. Verified status can be accompanied by benefits, such as improved transaction terms. The identity verification system 300 may, optionally, deny transactions not originating from the local machine 102 from which the user's identity was verified. A user can thus be confident that his account will not likely be misused, as sensitive transaction may only be available from the local machine or machines from which the user's identity was verified. Additionally, other users may benefit from a first user's verified status. For example, when other users interact with the verified first user, the other users can be confident that they are dealing with a real person or entity, whose identity and applicable authorizations have been confirmed. As a result, other users may be encouraged to enter into transactions with the verified first user.

An operator of the website 310 may also benefit from identity verification of website users. If an identity of a user has been verified, the website operator is less likely than otherwise to lose profits or credibility based on identity fraud. With respect to purchase card transactions, when the user's authorization to the use the purchase card has been verified, the website operator can be confident that chargebacks for unauthorized transactions will likely be avoided. Accordingly, to encourage users to verify their identities, the website operator may offer promotional benefits to users who participate in the identity verification process.

Through the capture unit 320 of the identity verification system 300, one or more verification images may be captured for verifying an identity of a user. The capture unit 320 may transmit one or more signals to the local machine 102, which in response to the signals, may initiate capture of the verification images via the capture device 305. Each signal or predetermined combination of signals may result in the capture of an individual verification image.

Before capturing any verification images, the capture unit 320 may determine whether the local machine 102 is operatively connected to a capture device 305. Preferably, if no capture device 305 is found, then identity verification may terminate.

The identity verification system 300 may request, or require, that the user provide images of certain objects or entities in one or all of the verification images. In an exemplary embodiment, before capturing each verification image, the capture unit 320 may prompt the user to place a predetermined set of objects or entities in a field of view of the capture device 305. For example, and not limitation, before capture of the first verification image, the capture unit 320 may prompt the user to position the user's face in the field of view of the capture device 305. The capture unit 320 may provide a preview on the website 310 of each verification image before capture of the verification image. For example, the website 310 may display a frame, or outline, which may enclose or partially enclose an image of objects and entities in the field of view of the capture device 305.

When two or more objects or entities are to be captured, the website may display two or more frames, one for each object or entity, to guide the user to position the objects and entities as desired. The frames may have various shapes, which are preferably indicative of the objects or entities to be framed. For example, the capture unit 320 may be configured to prompt the user to position both the user's face and a photo identification card in the field of view of the capture device 305 for the second verification image. In that case, the website 310 may, for example, display a rectangular frame in proximity to an oval frame. This may indicate that the user is requested to position the user's face and photo identification card in the field of view of the capture device such that a preview of the verification image illustrates the face within the oval, and the card within the rectangle.

When the user is satisfied with placement of objects or entities in the field of view of the capture device 305, the user may indicate to the website 310 that a verification image may be captured. Such indication may occur by the user's providing predetermined input to the website 310. For example, and not limitation, the user may click a link or button on the website 310 to indicate the user's approval. As a result of the user's indicated approval, the capture unit 320 may transmit one or more signals to the local machine 102, which may result in the capture device 305 capturing an image of objects and entities in the field of view of the capture device 305.

Alternatively, the website 310 may provide a timer, which may be activated by the user. After activation, the timer may expire after a predetermined time period, which may be set by the user or may be a default time period. At expiration of the time period, the capture unit 320 may transmit one or more signals to the local machine 102, which may result in the capture device 305 capturing an image of objects and entities in the field of view of the capture device 305. Such a timer embodiment enables the user to utilize both hands when placing objects and or entities in the field of view of the capture device 305.

The capturing process may be repeated for each verification image. The collection of verification images may comprise various combinations of images that may be utilized to verify the identity of the user, or to verify authorization of the user to utilize a certain purchase method. In an exemplary embodiment of the identity verification system 300, the verification images depict, at least, the user and an identification document associated with the user. One of skill in the art, however, will recognize that many combinations of images may constitute the verification images.

In an exemplary embodiment of the identity verification system 300, a first verification image may comprise an image of the user holding an identification document associated with the user. For example, this can consist of a person holding his driver's license, such that the person's face and license are visible in the first verification image. In addition to verifying identity, such an image may be used to verify that the user has physical possession of the identification document. Alternatively, the first verification image may depict only the user, without the identification document. A second verification image may comprise a close-up of the identification document, which, preferably, clearly illustrates a person associated with the identification document. Additional verification images may comprise, for example, an image of a voter registration card or other identification document that may, but need not, include a photograph.

The delivery unit 330 of the identity verification system 300 may transmit the verification images from the local machine 102 to the server assembly. In an exemplary embodiment of the identity verification system 300, such transmission is implemented in a secure fashion to protect the sensitivity of the verification images. Accordingly, before being transmitted to the server assembly, the verification images may be stored on a storage device or unit on, or associated with, the local machine 102. The verification images may be encrypted or otherwise protected while on the local machine 102 and may remain encrypted after transmission to the server assembly 230.

After the verification images are received by the server assembly 230, the verification unit 340 of the identity verification system 300 may verify the user's identity. In an exemplary embodiment, verification may comprise comparing elements of the verification images to one another. For example, and not limitation, a face of the user depicted in a first verification image may be compared to a photo identification depicted in the first verification image or in a different verification image. A name on a on a purchase device may be compared to a name on a photo identification. Such comparison may occur manually and results may be entered into the verification unit 340, or such verification may be implemented via facial recognition software.

Additionally, the verification unit 340 may verify the authenticity of documents depicted in the verification images. For example, the verification unit 340 may analyze, or receive results of manual analysis, of a watermark appearing on a photo identification. Additionally, the verification unit 340 may extract information from a verification image of a purchase device, and may verify the extracted information with an issuing bank of the purchase device. Thus, the verification unit 340 may determine authenticity of the purchase device or verify that the user is authorized to use the purchase device.

The verification unit 340 may contact third party information sources to further verify the user's identity, document authenticity, or both. For example, a third party may provide or verify a user's residence history, name, address, birthday, or other information. With the information received from third parties, the verification unit 340 may provide validation that the user is authorized to use an account associated with a purchase device. Such validation may comprise manually or electronically transmitting the user's name and purchase account data to a third party, such as a bank or credit card company, associated with the purchase device. The verification unit 340 may then receive validation, or the contrary, that the user is authorized to use the purchase device for financial transactions. If the third party indicates that the user is not authorized, the identity verification system 300 may deny transactions with the purchase device via the user's user account.

If the user has a user account 360 on the website 310, the user account 360 may be flagged in some manner to indicate that the user account has been verified. Flagging may take various forms. For example, and not limitation, the server assembly 230 or associated storage device may retain the verification images and associate such images with the user account 360. Additionally, or alternatively, the identity verification system 300 may create or update one or more variables in a database to indicate that the user's identity has been verified.

Transactions utilizing the identity verification system 300 may be routed through the transaction unit 350. The transaction unit 350 may determine whether a transaction has verified status.

For example, if the verification images are retained in the identity verification system 300, the verification image may, but need not, be utilized to verify the user's identity for individual transactions. When a transaction is requested via the user's user account 360, the website 310 may detect whether a capture device 305 is connected to the local machine 102. If a capture device 305 is detected, the website may prompt, or require, the requestor to provide an image of the requestor for identity verification to authorize the transaction.

The image may be transmitted to the server assembly, and may be compared to one or more verification images to determine whether the requestor is the user or is authorized to conduct transactions via the user's user account 360. Such comparison may be implemented via facial recognition software, manually, or by various other means of determining whether a face on the image substantially matches a face in the verification images. If it cannot be determined that the requestor's face matches a face in the verification images, the transaction may be denied or may fail to qualify for verified status.

In another exemplary embodiment of the identity verification system 300, the website 310 may detect an identifier, such as an IP address or MAC address, of the local machine 102 from which the verification images are transmitted. This identifier may be stored in a storage device in communication with the server assembly 230, and may be associated with the user's user account 360. In that case, when a transaction is conducted via the user account 360, the transaction may qualify for verified status only when originating from a local machine 102 from which the user's identity was verified.

In an alternate exemplary embodiment, all transactions, or all transactions having predetermined characteristics, originating from the user account 360 may be afforded verified status.

Transactions having verified status may afford certain protections to the website operator. For example, and not limitation, the website operator may use verified status as evidence in alleging that a person conducting transactions from a verified user account 360 is authorized to conduct such transactions. Accordingly, the website operator may be protected from potential chargeback transactions or allegations of user account misuse. Additionally, because a website operator may refuse to conduct business without identity verification, transactions may be required to be verified.

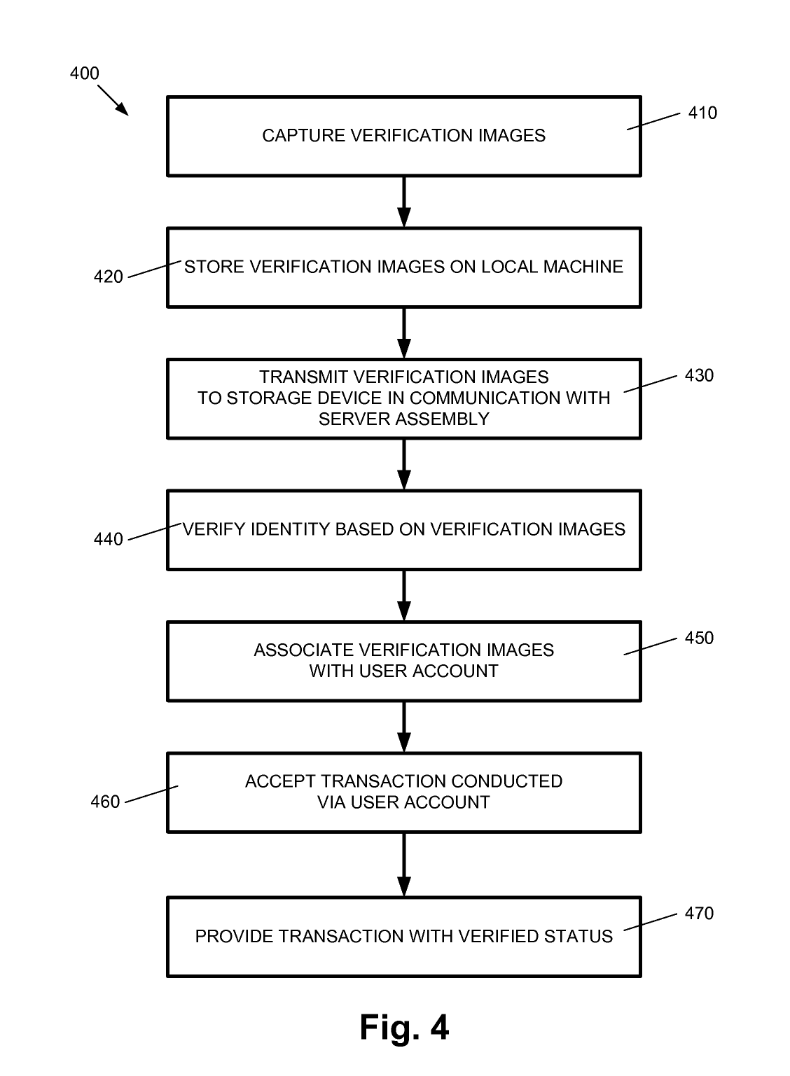

The various components of the identity verification system 300 may work in conjunction to receive and verify an identity of a user. FIG. 4 illustrates an exemplary method 400 for verifying a user's identity and handling a transaction conducted via the user's user account 360.

As shown in FIG. 4, at 410, the identity verification system 300 may capture one or more verification images of the user and identification or financial documents associated with the user. Such capture may utilize a website 310. For example, the user may have a user account 360 with the website 310, and may request identity verification to enhance the user's interaction with the website 310. When the user indicates via the website 310 that the user is prepared for an image to be captured, the identity verification system 300 may signal a capture device 305 in communication with the local machine 102 to capture a verification image.

At 420, the verification images may be stored, at least temporarily, on a local machine 102 of the user. The verification images may be encrypted on the local machine 102, and then transmitted to a storage device in communication with the server assembly, at 430.

At 440, the user's identity may be verified based at least partially on the verification images. This verification process may comprise comparing an image of an identification document, such as a photo identification card, to an image of the user. At 450, the verification images may be associated with the user account 360 of the user, thereby indicating that the user's identity has been verified.

At 460, the user may request a transaction via the user's user account. The identity verification system 300 may then determine whether all criteria for a verified transaction are met. If instituted, such criteria may include, for example, whether the transaction originates from the local computer from which the user's identity was verified, or whether a face in an image captured during the transaction request matches a face in a verification image. Alternatively, the criteria may simply require that the user's identity has been verified at some point and from some machine. If the criteria are met, the transaction may be afforded verified status, at 470.

Accordingly, the identity verification system 300 may enable remote identity verification for conducting transactions remotely with reduced risk to one or more parties to the transactions.

While the identity verification system 300 has been disclosed in exemplary forms, it will be apparent to those skilled in the art that many modifications, additions, and deletions may be made without departing from the spirit and scope of the system, method, and their equivalents, as set forth in the following claims.

What is claimed is:

1. A method for verifying an identity of a user, the method comprising:
initiating capture of a first image of the user;
initiating capture of a second image of a first identification document of the user;
transmitting the first image and the second image to a server assembly remote from the user; and
verifying the identity of the user based on the first image and the second image.

2. The method of claim 1, further comprising electronically storing the first image and the second image in a storage unit associated with a local machine of the user.

3. The method of claim 1, further comprising associating the first image and the second image with the user.

4. The method of claim 1, wherein the first image is captured via a web camera associated with the local machine.

5. The method of claim 1, further comprising initiating capture of a third image of a second identification card of a user.

6. The method of claim 5, the second identification card being a purchase device.

7. The method of claim 6, further comprising receiving identity validation from a financial company associated with the purchase device.

8. The method of claim 1, further comprising encrypting the first image and the second image before transmitting the first image and the second image to the server assembly.

9. The method of claim 1, further comprising determining an identifier for the local machine of the user, and affording a verified status to transactions from the local computer without further identification verification.

10. The method of claim 1, further comprising initiating capture of a third image of the user when the user requests to purchase a good or service, and comparing the third image to one of the first image and the second image to verify the identity of the user.

11. The method of claim 1, further comprising activating a specialized light to illuminate protective content on the identification document.

12. An identity verification system comprising:
a capture unit configured to prompt a user to position the user and a first identification document associated with the user in a field of view of a capture device, and further configured to capture one or more verification images of the user and the first identification document;
a delivery unit for transmitting the verification images to a server assembly;
a verification unit for providing verification of the user's identity based on the verification images;
a user account associated with the user, the user account associated with the verification images, wherein business transacted via the user account is associated with the verification images; and
a transaction unit for receiving one or more transaction requests from the user.

13. The system of claim 12, the capture unit further configured to prompt the user to position a second identification document associated with the user in a field of view of the capture device, and further configured to capture an image of the second identification document.

14. The system of claim 13, the second identification document being a purchase card.

15. The system of claim 14, the verification unit further configured to confirm with a third party that the user is authorized to make purchases with the purchase card.

16. The system of claim 12, the capture unit further configured to transmit a signal to a camera, the signal initiating capture of an image via the camera.

17. The system of claim 12, the capture unit further configured to capture at least one of the verification images after expiration of a timer.

18. The system of claim 12, the capture unit further configured to capture at least one of the verification images in response to an input from the user.

19. The system of claim 12, the transaction unit further configured to refuse purchases with the purchase card when the user's authorization to use the purchase card is not confirmed.

20. The system of claim 12, the transaction unit configured to afford verified status to transactions via the user's user account based at least partially on analysis of the verification images.

21. The system of claim 12, wherein providing verification of the user's identity based on the verification images comprises manually comparing the first image to the second image.

22. A computer program product embodied in a computer-readable medium, the computer program product comprising an algorithm adapted to effectuate an identity verification system comprising:
transmitting a first signal to a camera in communication with a local machine of the user, the first signal initiating capture of a first image of the user;
transmitting a second signal to the camera in communication with the local machine of the user, the second signal initiating capture of a second image of a first identification document of the user;
transmitting the first image and the second image to a server assembly at a remote location with respect to the local machine;
comparing the first image to the second image to verify an identity of the user; and
marking one or more transactions conducted via a user account of the user with verified status affording a verification privilege.

23. The computer program product of claim 22, further comprising transmitting a third signal to the camera in communication with the local machine of the user, the third signal initiating capture of a third image of a second identification document or a purchase device.

24. The computer program product of claim 22, further comprising determining an identifier for the local machine of the user.

25. The computer program product of claim 24, further comprising confirming the identifier for the local machine before affording verified status to a transaction originating from the local machine.
